(19) United States
(12) Patent Application Publication
(10) Pub. No.: US 2015/0370737 A1
(43) Pub. Date: Dec. 24, 2015

(54) SMARTPHONE HAVING FULL SIZE USB PORT

(71) Applicant: Deandre Perkins, Milwaukee, WI (US)

(72) Inventor: Deandre Perkins, Milwaukee, WI (US)

(21) Appl. No.: 14/309,506

(22) Filed: Jun. 19, 2014

(51) Int. Cl. G06F 13/38; G06F 13/28

(52) U.S. Cl. CPC G06F 13/385; G06F 13/28; G06F 2213/2802; G06F 2213/3806

(57) ABSTRACT

A USB smartphone for enabling the connection and interfacing of a standard size USB plug, typically from a USB flash drive, with a mobile computer such as a smart phone. The USB smartphone comprises a device body which include an external USB port, and internal USB mass storage device class standard software. The device body is defined as a conventional smartphone mobile computer and the USB port is defined as a downstream-port receptacle adapted to receive a Standard-A type USB plug. In operation, when a conventional USB flash drive is plugged into the device body, a directory of the USB flash drive is accessible through the display interface of the device body and files can be transferred between the memory of the device body and of the USB flash drive.

### BACKGROUND OF THE INVENTION

1. Field of the Invention

This invention relates generally to mobile computers and, more particularly, to a smartphone having a full size, integrated universal serial bus port.

2. Description of the Prior Art

The use of mobile computers, such as smartphones and tablets, for storing, transporting and uploading all types of computer data is well known. Such devices commonly have data such as photo files, document files, and music files on their internal memory. Such files are commonly downloaded from another device or uploaded to another device; and this functionality is conventionally enabled through a connection to a wireless computer data network. A problem which still exists, however, is that a connection to a wireless data network is not always available; and when one is not available, transferring data files to and from a smartphone may require proprietary hardware accessories which are not always readily available. Thus, there remains a need for a universal serial bus (“USB”) smartphone having a serial port for interfacing with a conventional data storage device. It would be helpful if the serial port on such a USB smartphone utilized a standard size USB port for receiving USB flash drives. It would be additionally desirable for the serial port on such a USB smartphone to enable the smartphone to receive other USB drive devices, such as interface control USB devices (i.e. a USB mouse or USB keyboard).

The Applicant's invention described herein provides for a USB smartphone adapted to interface directly with USB flash drives to avail the storage thereon to the smartphone. The primary component in Applicant's USB smartphone is a conventional smartphone with a standard size USB receptacle. When in operation, the USB smartphone enables USB flash drives to be directly received and data to transferred between the USB smartphone and the USB flash drive. As a result, many of the limitations imposed by prior art structures are removed.

### SUMMARY OF THE INVENTION

A USB smartphone for enabling the connection and interfacing of a standard size USB plug, typically from a USB flash drive, with a mobile computer such as a smart phone. The USB smartphone comprises a device body which include an external USB port, and internal USB mass storage device class standard software. The device body is defined as a conventional smartphone mobile computer and the USB port is defined as a downstream-port receptacle adapted to receive a Standard-A type USB plug. In operation, when a conventional USB flash drive is plugged into the device body, a directory of the USB flash drive is accessible through the display interface of the device body and files can be transferred between the memory of the device body and of the USB flash drive.

It is an object of this invention to provide a need for a USB smartphone having a serial port for interfacing with a conventional data storage device.

It is another object of this invention to provide a USB smartphone having serial port which utilizes a standard size USB port for receiving USB flash drives.

It is yet another object of this invention to provide a USB smartphone having serial port that enabled the smartphone to receive other USB drive devices, such as interface control USB devices (i.e. a USB mouse or USB keyboard).

These and other objects will be apparent to one of skill in the art.

### BRIEF DESCRIPTION OF THE DRAWINGS

FIG. 1A is a front elevational view of a USB smartphone built in accordance with the present invention.

FIG. 1B is a side elevational view of a USB smartphone built in accordance with the present invention.

### DETAILED DESCRIPTION OF THE INVENTION

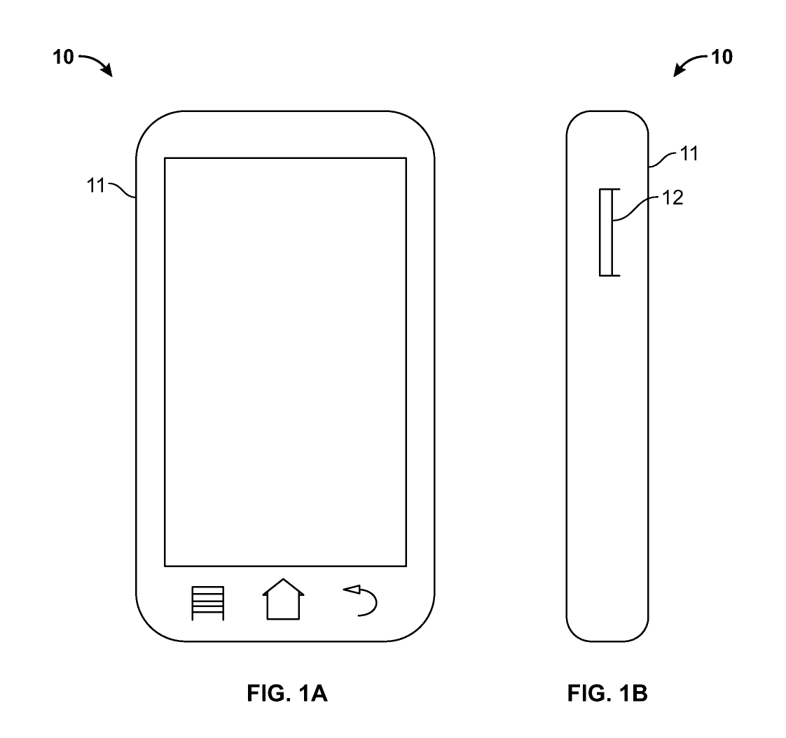

Referring now to the drawings and in particular FIGS. 1A and 1B, a USB smartphone 10 is shown having a device body 11 and a USB port 12. The device body 11 is defined as a conventional smartphone mobile computer. It is contemplated, however, that in other embodiments, the device body 11 may alternatively define other mobile devices, such as a conventional tablet mobile computer, a mobile digital media player (or portable media player, digital audio player, portable MP3 player), a digital camera, or a wearable computing device (such as a computing device embedded in glasses, wristwear, or a necklace).

The USB port 12 is defined as a downstream-port receptacle adapted to receive a Standard-A type USB plug. In this regard, in addition to facilitating the transmission of data, it is able supply electrical power therethrough.

The device body 11 is modified from a conventional smartphone through the inclusion of USB mass storage device class standards in the internal software of the device body 11. Through the inclusion of such standards, when a conventional USB flash drive is plugged into the device body 11, a directory of the USB flash drive is accessible through the user interface of the device body 11. It is through this user interface that files can be transferred between the memory of the device body 11 and of the USB flash drive.

It is contemplated that a USB plug for a USB accessory such as a keyboard or mouse may additionally be interfaced with the device body 11. Through such action, a keyboard can be connected to the device body and used to operate the user interface. In another scenario, a USB monitor may be connected to the device body 11 to supplement or even temporarily replace the display screen of the device body 11. This could be extremely helpful in a data recovery situation wherein the display screen of the device body is not operational.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A USB smartphone device, comprising:
a device body having a housing with a processor, non-volatile memory, a user interface, and power source disposed therein;
a USB port integral in said housing, wherein said USB port is defined as a downstream-port receptacle adapted to receive a Standard-A type USB plug; and
wherein said non-volatile memory includes instructions which enables the processor to make accessible through the user interface and enable transfer of data between a conventional USB plug device inserted into the USB port and the non-volatile memory.

2. A USB mobile computer device, comprising:
a device body having a housing with a processor, non-volatile memory, a user interface, and power source disposed therein;
a USB port integral in said housing, wherein said USB port is defined as a downstream-port receptacle adapted to receive a Standard-A type USB plug; and
wherein said non-volatile memory includes instructions which enables the processor to make accessible through the user interface and enable transfer of data between a conventional USB plug device inserted into the USB port and the non-volatile memory.

3. The USB mobile computer device of claim 2, wherein said device body is defined as a tablet mobile computer.

4. The USB mobile computer device of claim 2, wherein said device body is defined as a mobile digital media player.

5. The USB mobile computer device of claim 2, wherein said device body is defined as a digital camera.

6. The USB mobile computer device of claim 2, wherein said device body is defined as a wearable computing device
